(19) United States
(12) Patent Application Publication
(10) Pub. No.: US 2008/0247473 A1
(43) Pub. Date: Oct. 9, 2008

(54) MULTIPLE SUB-BANDS TDS-OFDM TRANSMISSION SCHEME

(75) Inventor: LIN YANG, FREMONT, CA (US)

Correspondence Address: FRANK F. TIAN, 331-4A THIRD AVENUE, LONG BEACH, NJ, 07740, US

(73) Assignee: LEGEND SILICON CORP., FREMONT, CA (US)

(21) Appl. No.: 11/697,920

(22) Filed: Apr. 9, 2007

(51) Int. Cl. H04L 23/02

(52) U.S. Cl. 375/260

(57) ABSTRACT

An OFDM system is provided. The system comprises: a single symbol among a series of symbols comprising; and a series PN sequences interposed between the series of symbols, with at least one PN sequence comprising a set of PN sub-sequences, wherein each PN sub-sequence is respectively associated with an ordered sub-central frequency within the single symbol.

### FIELD OF THE INVENTION

The present invention relates generally to TDS-OFDM systems, more specifically the present invention relates to a TDS-OFDM system having a set of PN sequences each respectively modulated by a pre-defined frequency within a single TDS-OFDM frame.

### BACKGROUND

TDS-OFDM is known. Typically, in TDS-OFDM a packet of transmitted or a received packet have PN sequence as guard intervals. The PNs containing information therein can be used advantageously for various purposes. When multiple bands are provided in an OFDM or data packet, the associated PN is desired to contain information corresponding to the multiple bands in the symbol.

Therefore, it is desirous to have PN sequence associated with the multiple bands.

### SUMMARY OF THE INVENTION

In an OFDM system, a frame or symbol is subdivided in the frequency domain within a single frame for the data portion only.

In an OFDM system, a set of PN sequences acting as guard intervals are provided. Each PN sequence comprises elements that are respectively modulated onto a set of predefined frequencies defined within the single frame.

A TDS-OFDM system is provided. The system comprises: a single frame among a series of frames comprising; and a series PN sequences interposed between the series of frames, with at least one PN sequence comprising a set of PN sub-sequences, wherein each PN sub-sequence is respectively associated with an ordered sub-central frequency within the single frame.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of a TDS-OFDM symbol in the time domain in accordance with some embodiments of the invention.

FIG. 2 is an example of a data segment and its modulated PN in accordance with some embodiments of the invention.

FIG. 2A is a detailed example of the modulated PN of FIG. 2.

FIG. 2B is a detailed example of the data segment of FIG. 2.

FIG. 3 is a practical example of FIG. 2.

FIG. 3A is a detailed example of the modulated PN of FIG. 3.

FIG. 3B is a detailed example of the data segment of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a TDS-OFDM system having a set of PN sequences with each PN acting as guard interval between its respective symbols modulated onto a set of predefined frequencies, wherein each symbol is further subdivided in accordance with an ordered sub-central frequency into a plurality of frequency associated elements, and each of the associated elements respectively corresponds elements within an associated PN having elements with one-to-one relationship with the associated elements of the symbol. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of a TDS-OFDM system having a set of PN sequences each respectively associated with an ordered sub-central frequency modulated onto a set of predefined frequencies within a single frame described herein. The non-processor circuits may include, but are not limited to, a radio receiver, a radio transmitter, signal drivers, clock circuits, power source circuits, and user input devices. As such, these functions may be interpreted as steps of a method to perform a TDS-OFDM system having a set of PN sequences each respectively associated with an ordered sub-central frequency within a single frame. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

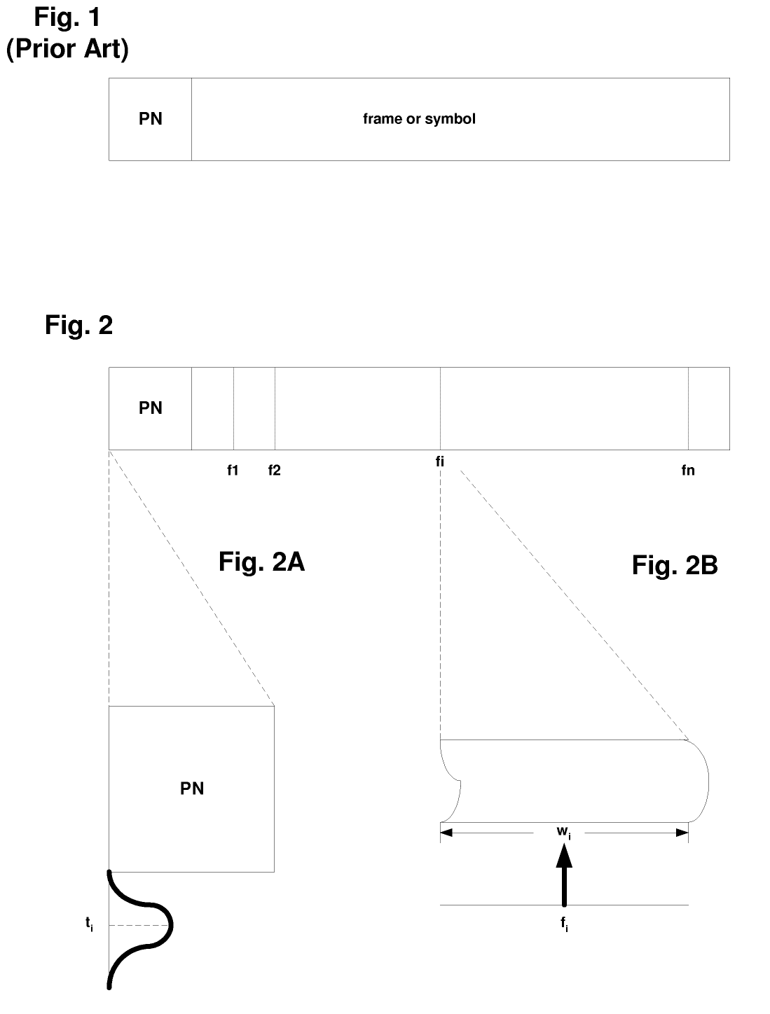

Referring to FIG. 1, a typical TDS-OFDM frame or symbol with its associated PN sequence is shown. Packets are positioned sequentially within a frame among a multiplicity of packets. As can be appreciated, PNs are disposed between the OFDM symbols or data segments that are typically in the time domain. It is noted that the present invention contemplates using the PN sequence disclosed in U.S. Pat. No. 7,072,289 to Yang et al which is hereby incorporated herein by reference.

Referring to FIG. 2, for each frame having a symbol or data segment and a PN sequence, the data segment is transformed into the frequency domain with its bandwidth subdivided in a predetermined manner. In other words, the transformed data segment is further sub-divided in the frequency domain into sub-frequencies or central frequencies fᵢ having sub-bands wᵢ, where i=1, . . . , n. The sub-band wᵢ may have equal or unequal bandwidth. The central frequencies fᵢ may have an ordered relationship among other central frequencies depending upon TDS-OFDM systems' parameters. Each associated PN that typically acts as guard intervals is further used as an indication of or in association with the sub-bands, while the PN being still in a time domain. The symbol or data segment of a frame is further subdivided in the frequency domain into sub-bands each having a central frequency; and the associated PN with the data segment has elements or parameters therein, in the time domain, associated with each sub-bands or central frequencies respectively. The above mentioned association exists between the central frequencies fᵢ where i=1, . . . , n in the frequency domain and the PN elements in the time domain.

Referring to FIGS. 2A-2B, a detailed modulation back from the F domain of a central frequencies fᵢ back to the associated PN sequency in the t domain is shown. In other words, the PNs in the time domain are used for possessing information on a set of predetermined, associated central frequencies in the frequency domain by modulating the central frequencies back to the time domain and maintained by some parameters in the PN sequence. The modulated frequencies fᵢ where i=1, . . . , n with the associated bandwidth wᵢ are respectively represented by a set of parameters of the PN sequence. Thereby PN sequences are used for maintaining or possessing a set of subdivisions of its associated data segment. It should be noted that the PNs are not transformed into the frequency domain. PNs are still in the time domain. The associated frequencies fᵢ where i=1, . . . , n is modulated back onto their respective PNs. As can be seen, data segment in the Frequency domain is divided into n subband, fi, wherein each fᵢ has a bandwidth, wᵢ. The associated PNs are still in the time domain.

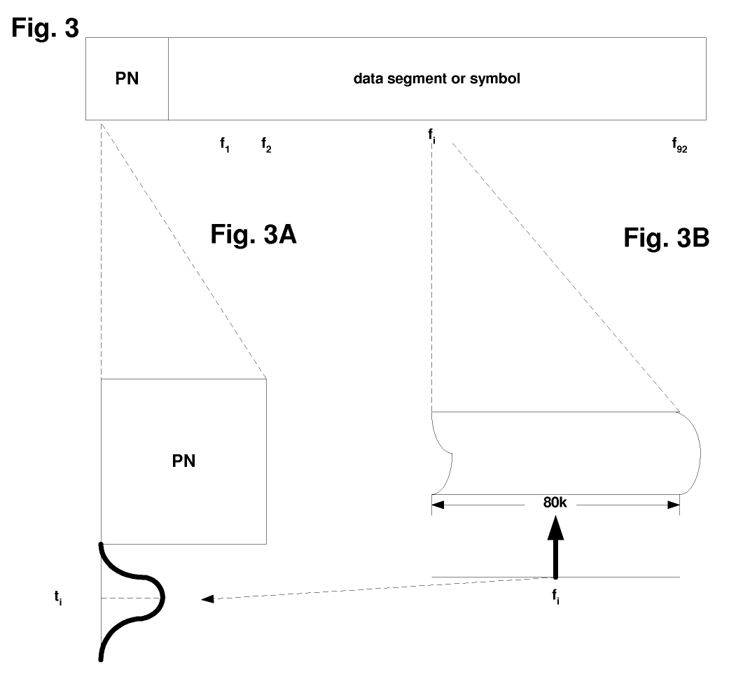

Referring to FIG. 3, an exemplified depiction of FIG. 2 is shown. In FIG. 3, the example is associated with a 3780-point IFFT system for a TDS-OFDM terrestrial DTV transceiver or receiver using subbands are shown. The system is divided into 92 (n=92) subcarriers. In other words, each data segment comprises 92 central frequencies fi where i=1, . . . , 92. Each fi has an associated bandwidth wi having a value of 80 kHz. One subband comprises 40 subcarriers all of which can be modulated back to the time domain having their respective information kept in their respective PN sequences. As can be seen, the data frame part is defined in F domain and transformed to t domain using an inverse Fourier transform such as inverse fast Fourier transform (IFFT) and is combined with the associated PN defined in the t domain. One subband comprises forty (40) subcarriers.

In an OFDM system, a method is provided. The method comprises the steps of: providing a symbol among a series of symbols; and providing a series PN sequences interposed between the series of symbols, with at least one PN sequence comprising a set of PN sub-sequences, wherein each PN sub-sequence is respectively associated with an ordered sub-central frequency within the symbol.

An OFDM system comprising: a symbol among a series of symbols adapted to be received by a receiver; and a series PN sequences interposed between the series of symbols, with at least one PN sequence comprising a set of PN sub-sequences, wherein each PN sub-sequence is respectively associated with an ordered sub-central frequency within the symbol.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

What is claimed is:

1. An OFDM system comprising:
a symbol among a series of symbols adapted to be received by a receiver; and
a series PN sequences interposed between the series of symbols, with at least one PN sequence comprising a set of PN sub-sequences, wherein each PN sub-sequence is respectively associated with an ordered sub-central frequency within the symbol.

2. The system of claim 1, wherein the data portion of the symbol is transformed into a frequency domain and subdivided into a set of subcentral frequencies including the ordered sub-central frequency.

3. The system of claim 1, wherein each PN sequence comprises elements that are respectively modulated onto a set of predefined frequencies.

4. The system of claim 1, wherein the sub-central frequency is predetermined.

5. The system of claim 1, wherein sub-central frequency has a bandwidth.

6. The system of claim 5, wherein the bandwidth comprises 2 K.

7. The system of claim 2, wherein each PN sub-sequence comprises 40 sub-bands.

8. The system of claim 1, wherein the OFDM system comprises a TDS-OFDM system.

9. The system of claim 1, wherein the TDS-OFDM system comprises a 3780-point IFFT system.

10. The system of claim 1, wherein the number of sub-bands equals 92.

11. In an OFDM system, a method comprising the steps of:
providing a symbol among a series of symbols; and
providing a series PN sequences interposed between the series of symbols, with at least one PN sequence comprising a set of PN sub-sequences, wherein each PN sub-sequence is respectively associated with an ordered sub-central frequency within the symbol.

12. The method of claim 11 further comprising the step of transforming the symbol or the data portion of the symbol to the frequency domain.

13. The method of claim 12 further comprising the step of determining a set of sub-central frequencies within the transformed symbol.

14. The method of claim 11, wherein the set of sub-central frequencies is predetermined.

15. The method of claim 11, wherein each PN sequence comprises elements that are respectively modulated onto a set of predefined frequencies.
